(19) United States
(12) Patent Application Publication
(10) Pub. No.: US 2020/0410484 A1
(43) Pub. Date: Dec. 31, 2020

(54) SYSTEM AND METHOD FOR PROVIDING SCALABLE CROSS DOMAIN CONTEXTUAL VAULTING

(71) Applicant: PAYPAL, INC., SAN JOSE, CA (US)

(72) Inventors: Srinivasa Praveen Kumar Kidambivenkata, Cupertino, CA (US); Jagdeesh Babu Marisettyraghu, San Jose, CA (US); Satya Kumar Akkireddy, San Jose, CA (US)

(21) Appl. No.: 16/458,180

(22) Filed: Jun. 30, 2019

(51) Int. Cl. G06Q 20/38; G06Q 20/20; G06Q 20/36; G06Q 20/22

(52) U.S. Cl. CPC G06Q 20/387; G06Q 20/227; G06Q 20/3678; G06Q 20/204

(57) ABSTRACT

A system and method for provisioning of scalable cross domain contextual vaulting is described. An initiation of a checkout at a partner merchant by a consumer client is received at a payment provider. A set of funding instruments vaulted in the consumer client's digital wallet associated with the payment provider is identified. Promotions offered by each of the set of funding instruments at the partner merchant are further identified. A ranking of the set of funding instruments is determining based on the promotions offered. payment options for the checkout based on the ranking of the set of funding instruments are presented to the consumer client.

### TECHNICAL FIELD

The subject technology generally relates to managing financial instruments and more particularly, relates to a system and method for providing scalable cross domain contextual vaulting.

### BACKGROUND

Consumers who shop, whether online or at retail locations, have many preferences. One area where customers have an abundance of options is the financial instrument with which they choose to pay. For example, some merchants provide certain discounts for cash and cash equivalent transfers. Some merchant may accept certain credit card but not others. Within the credit cards themselves, each card may provide different incentives that vary depending on merchant category (e.g., travel, gas station, restaurants, grocery stores, etc.). In some instances, certain cards may be partnered with certain merchants, and offer customized discounts specific to that card and merchant combination.

As such, it is nearly impossible for consumers to keep track of how one can maximize the benefits based on one's choice of financial instruments. On top of that, consumers may value the benefits differently from one another, thus adding an element of dynamism to what is considered optimal. Accordingly, there needs to be a system in place that can provide, to a consumer, a ranked list of financial instruments that can be used for a specific transaction.

### SUMMARY

According to various aspects of the subject technology, a system for providing scalable cross domain contextual vaulting is described. A system and method for provisioning of scalable cross domain contextual vaulting is described. An initiation of a checkout at a partner merchant by a consumer client is received at a payment provider. A set of funding instruments vaulted in the consumer client's digital wallet associated with the payment provider is identified. Promotions offered by each of the set of funding instruments at the partner merchant are further identified. A ranking of the set of funding instruments is determining based on the promotions offered. payment options for the checkout based on the ranking of the set of funding instruments are presented to the consumer client.

According to various aspects of the subject technology, a method for providing scalable cross domain contextual vaulting is described. A system and method for provisioning of scalable cross domain contextual vaulting is described. An initiation of a checkout at a partner merchant by a consumer client is received at a payment provider. A set of funding instruments vaulted in the consumer client's digital wallet associated with the payment provider is identified. Promotions offered by each of the set of funding instruments at the partner merchant are further identified. A ranking of the set of funding instruments is determining based on the promotions offered. payment options for the checkout based on the ranking of the set of funding instruments are presented to the consumer client.

According to various aspects of the subject technology, a non-transitory machine-readable medium having stored thereon machine-readable instructions executable for providing scalable cross domain contextual vaulting is described. A system and method for provisioning of scalable cross domain contextual vaulting is described. An initiation of a checkout at a partner merchant by a consumer client is received at a payment provider. A set of funding instruments vaulted in the consumer client's digital wallet associated with the payment provider is identified. Promotions offered by each of the set of funding instruments at the partner merchant are further identified. A ranking of the set of funding instruments is determining based on the promotions offered. payment options for the checkout based on the ranking of the set of funding instruments are presented to the consumer client.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 is a block diagram of an exemplary computing system on which the provision of scalable cross domain contextual vaulting may be performed.

FIG. 2 is a block diagram of an exemplary computer system suitable for implementing one or more devices of the computing system in FIG. 1.

FIG. 3 illustrates an exemplary process 300 for providing scalable cross domain contextual vaulting.

FIGS. 4a-4b provide example graphical depictions of the UI presented by the payment provider.

### DETAILED DESCRIPTION

One of the decisions customers often face when making purchases online is which financial instrument the customer should use. For example, if a consumer is buying airfare on Alaska Airlines, using an Alaska Airlines card will provide the consumer five points per dollar spend. Each card held by a consumer may have a different set of incentives. Thus, as the consumer's holding of credit cards increases, so does the confusion of which card is best for which transactions.

In order to serve better serve the needs of consumers, a payment processor which serves as a vault for holding consumer financial instruments (i.e., credit cards and bank accounts) may take on the role of rewards decisioning for the consumer. For example, if the consumer has multiple cards vaulted within and managed by a payment processor (e.g., PayPal Inc.), the payment processor may suggest a card to the consumer upon checkout at a merchant or any variety of marketplaces. In order for this process to be implemented, the payment processor may need to collect and process all the different offers that are being presented to each of the credit cards that are vaulted.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.). Furthermore, various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

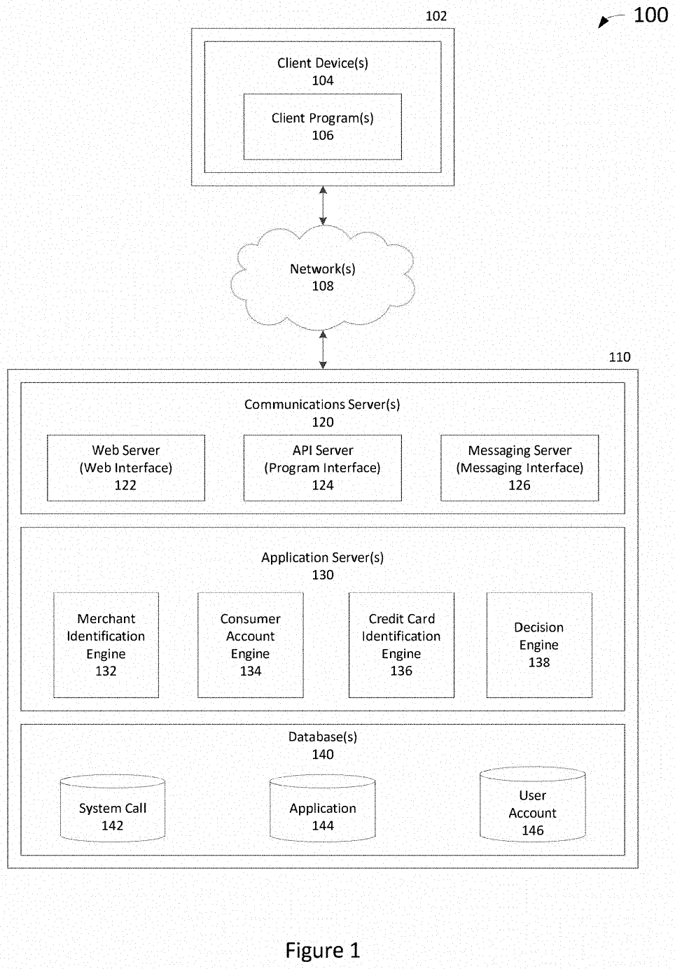

FIG. 1 is a block diagram of an exemplary computing system on which the provision of scalable cross domain contextual vaulting may be performed. As shown, a computing system 100 may comprise or implement a plurality of servers, devices, and/or software components that operate to perform various methodologies in accordance with the described embodiments. Exemplary servers, devices, and/or software components may include, for example, stand-alone and enterprise-class servers running an operating system (OS) such as a MICROSOFT® OS, a UNIX® OS, a LINUX® OS, or other suitable OS. It may be appreciated that the servers illustrated in FIG. 1 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing system 100 may include, among various devices, servers, databases and other elements, one or more clients 102 comprising or employing one or more client devices 104, such as a laptop, a mobile computing device, a tablet, a personal computer, a wearable device, and/or any other computing device having computing and/or communications capabilities in accordance with the described embodiments. Client devices 104 may also include a cellular telephone, smart phone, electronic wearable device (e.g., smart watch, virtual reality headset), or other similar mobile devices that a user may carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, iOS, Android, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a payment system application, a web browser application, messaging application, contacts application, calendar application, electronic document application, database application, media application (e.g., music, video, television), location-based services (LBS) application (e.g., GPS, mapping, directions, positioning systems, geolocation, point-of-interest, locator) that may utilize hardware components such as an antenna, and so forth. One or more of client programs 106 may display various graphical user interfaces (GUIs) to present information to and/or receive information from one or more users of client devices 104. In some embodiments, client programs 106 may include one or more applications configured to conduct some or all of the functionalities and/or processes discussed below.

As shown, client devices 104 may be communicatively coupled via one or more networks 108 to a network-based system 110. Network-based system 110 may be structured, arranged, and/or configured to allow client 102 to establish one or more communications sessions between network-based system 110 and various client devices 104 and/or client programs 106. Accordingly, a communications session between client devices 104 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data communications between client devices 104 and the network-based system 110 may be sent and received over one or more networks 108 such as the Internet, a WAN, a WWAN, a WLAN, a mobile telephone network, a landline telephone network, personal area network, as well as other suitable networks. For example, client devices 104 may communicate with network-based system 110 over the Internet or other suitable WAN by sending and or receiving information via interaction with a website, e-mail, IM session, and/or video messaging session. Any of a wide variety of suitable communication types between client devices 104 and system 110 may take place, as will be readily appreciated. In particular, wireless communications of any suitable form (e.g., Bluetooth, near-field communication, etc.) may take place between client device 104 and system 110, such as that which often occurs in the case of mobile phones or other personal and/or mobile devices.

Network-based system 110 may comprise one or more communications servers 120 to provide suitable interfaces that enable communication using various modes of communication and/or via one or more networks 108. Communications servers 120 may include a web server 122, an API server 124, and/or a messaging server 126 to provide interfaces to one or more application servers 130. Application servers 130 of network-based system 110 may be structured, arranged, and/or configured to provide various online services to client devices that communicate with network-based system 110. In various embodiments, client devices 104 may communicate with application servers 130 of network-based system 110 via one or more of a web interface provided by web server 122, a programmatic interface provided by API server 124, and/or a messaging interface provided by messaging server 126. It may be appreciated that web server 122, API server 124, and messaging server 126 may be structured, arranged, and/or configured to communicate with various types of client devices 104, and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, mobile applications, and so forth. API server 124 may be arranged to communicate with various client programs 106 comprising an implementation of API for network-based system 110. Messaging server 126 may be arranged to communicate with various messaging clients and/or applications such as e-mail, IM, SMS, MMS, telephone, VoIP, video messaging, IRC, and so forth, and messaging server 126 may provide a messaging interface to enable access by client 102 to the various services and functions provided by application servers 130.

Application servers 130 of network-based system 110 may be servers that provide various services such as tools for verifying URLs based on information collected about customers. Application servers 130 may include multiple servers and/or components. For example, application servers 130 may include a merchant identification engine 132, consumer account engine 134, credit card identification engine 136, and/or decision engine 138. These servers and/or components, which may be in addition to other servers, may be structured and arranged to provide scalable cross domain contextual vaulting.

Application servers 130, in turn, may be coupled to and capable of accessing one or more databases 140 including system call database 142, application database 144, and/or table database 146. Databases 140 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

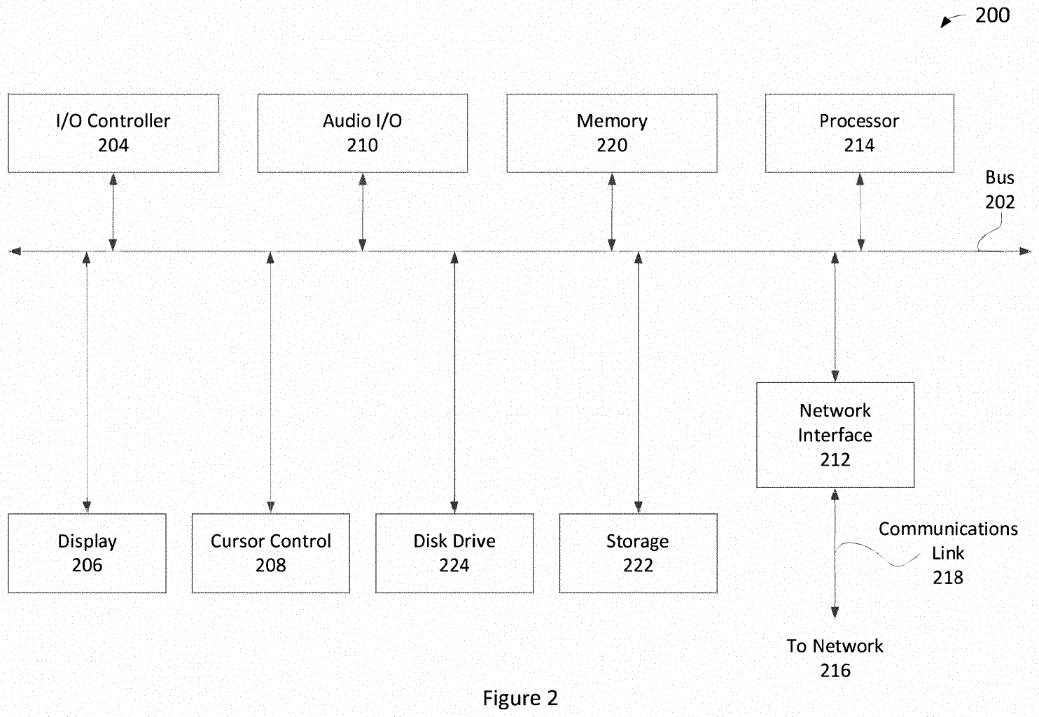

FIG. 2 illustrates an exemplary computer system 200 in block diagram format suitable for implementing on one or more devices of the computing system in FIG. 1. In various implementations, a device that includes computer system 200 may comprise a personal computing device (e.g., a smart or mobile phone, a computing tablet, a personal computer, laptop, wearable device, PDA, etc.) that is capable of communicating with a network. A service provider and/or a content provider may utilize a network computing device (e.g., a network server) capable of communicating with the network. It should be appreciated that each of the devices utilized by users, service providers, and content providers may be implemented as computer system 200 in a manner as follows. Additionally, as more and more devices become communication capable, such as smart devices using wireless communication to report, track, message, relay information and so forth, these devices may be part of computer system 200.

Computer system 200 may include a bus 202 or other communication mechanisms for communicating information data, signals, and information between various components of computer system 200. Components include an input/output (I/O) controller 204 that processes a user action, such as selecting keys from a keypad/keyboard, selecting one or more buttons, links, actuatable elements, etc., and sends a corresponding signal to bus 202. I/O controller 204 may also include an output component, such as a display 206 and a cursor control 208 (such as a keyboard, keypad, mouse, touchscreen, etc.). In some examples, I/O controller 204 may include an image sensor for capturing images and/or video, such as a complementary metal-oxide semiconductor (CMOS) image sensor, and/or the like. An audio I/O component 210 may also be included to allow a user to use voice for inputting information by converting audio signals. Audio I/O component 210 may allow the user to hear audio.

A transceiver or network interface 212 transmits and receives signals between computer system 200 and other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 214, which may be a micro-controller, digital signal processor (DSP), or other processing component, processes these various signals, such as for display on computer system 200 or transmission to other devices over a network 216 via a communication link 218. Again, communication link 218 may be a wireless communication in some embodiments. Processor 214 may also control transmission of information, such as cookies, IP addresses, images, and/or the like to other devices.

Components of computer system 200 also include a system memory 220 (e.g., RAM), a static storage component 222 (e.g., ROM), and/or a disk drive 224. Computer system 200 performs specific operations by processor 214 and other components by executing one or more sequences of instructions contained in system memory 220. Logic may be encoded in a computer-readable medium, which may refer to any medium that participates in providing instructions to processor 214 for execution. Such a medium may take many forms, including but not limited to, non-volatile media, volatile media, and/or transmission media. In various implementations, non-volatile media includes optical or magnetic disks, volatile media includes dynamic memory such as system memory 220, and transmission media includes coaxial cables, copper wire, and fiber optics, including wires that comprise bus 202. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer-readable media. It is also contemplated that software identified herein may be implemented using one or more computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof may be used to implement one or more services, such as the services discussed above and in more detail below.

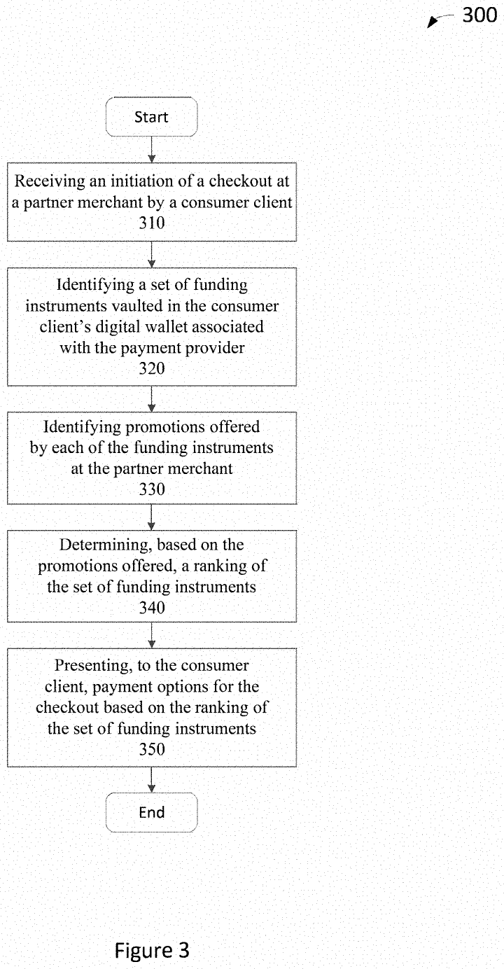

FIG. 3 illustrates an exemplary process 300 for providing scalable cross domain contextual vaulting. In step 310, an initiation of a checkout at a merchant by a consumer client is received at a payment provider. In this instance, the payment provider may be any company that provides payment services for customer clients. For example, PayPal, Inc., as a payment provider, serves as an intermediary that handles transactions between merchants and consumers who they serve as clients. When the consumer initiates a checkout at certain merchants, PayPal may be provided as a payment option, meaning the consumer can use PayPal's services to securely pay for the transaction.

In step 320, a set of funding instruments vaulted in the consumer client's digital wallet associated with the payment provider is identified. The vaulted funding instruments are the credit cards that the consumer has linked to his payment provider account, and that can be used to pay for a transaction. For example, the consumer may vault a number of credit cards, and in some instances, may vault a bank account on the payment provider platform. Vaulting may occur during an onboarding process. Alternatively, a consumer may vault a funding instrument after the account has been established.

In step 330, promotions offered by each of the funding instruments at the merchant are identified. In some embodiments, these promotions are funding instrument related promotions. Certain funding instruments (i.e., credit cards), offer certain incentives for card holders to use the card. For example, a credit card offered by a specific financial institution (e.g., Chase) may offer 5% cash back for purchases at a specific merchant (e.g., Macy's). In another example, the credit card may offer extra points for usage at certain merchants, or certain categories of merchants. For instance, Chase may offer 5×'s points for grocery purchases.

By identifying all the promotions being offered by the available funding instruments, the system can determine a ranking of the set of funding instruments in step 340. This ranking may be determined based on the size of the incentive. That is, the larger the incentive to use a funding instrument, the higher rank that funding instrument is assigned.

The ranked set is then presented to the consumer client as payment options for the checkout in step 350. For example, during checkout, the payment provider may present a user interface (UI) that includes a list of funding instruments that are usable for completing the checkout transaction. This list may be sorted such that the funding instrument with the largest incentive will be presented the highest in a set of available funding instruments for a particular checkout. The motivation behind such a sorting is to provide the user a recommendation as to which funding instrument to use, while also giving the user a choice in the funding instrument.

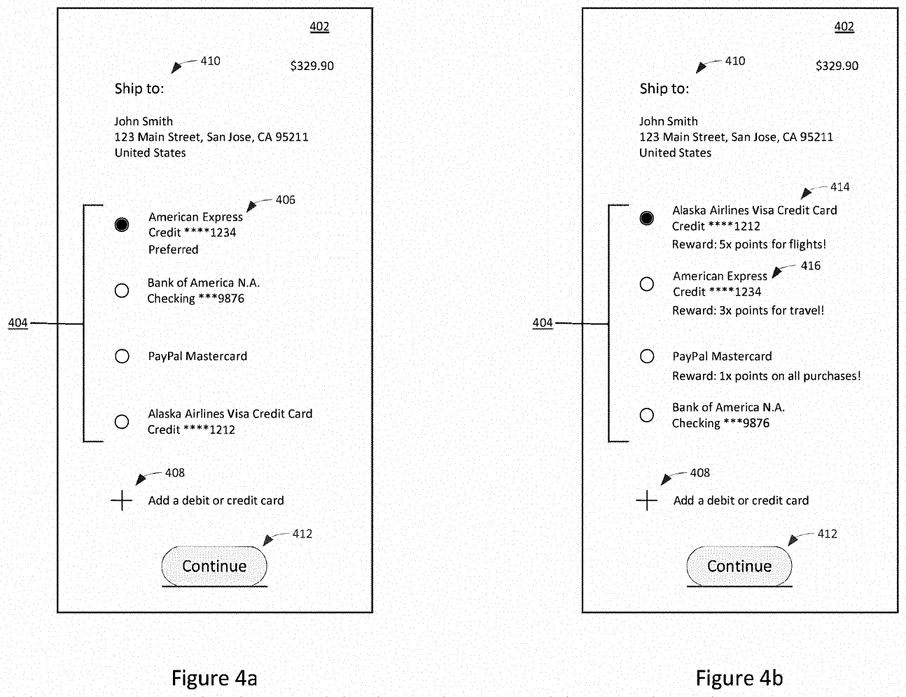

FIGS. 4a-4b provide example graphical depictions of the UI presented by the payment provider. In FIG. 4a, the payments page provided by the payment provider is a traditional checkout page 402. On this page, the user's funding instruments 404 are sorted based on preferences set by the consumer client, with the preferred funding instrument 406 at the top. In some instances, the consumer client is provided the option to add a funding instrument at checkout. To do so, the consumer client may click on the add funding instrument section 408, at which point the user may be directed to an alternate screen for entering information for a new funding instrument.

In some embodiments, the checkout is for an item that is to be shipped. Accordingly, a name on the account as well as a shipping address are provided in the “ship to” section 410. Once the consumer client has selected a payment method and clicked continue 412, payment will be processed for the item listed to be purchased from the merchant.

In FIG. 4b, the information provided in the UI is substantially the same as FIG. 4a. However, the order in which the funding instrument is listed is different by virtue of the intelligent sorting provided by the system described in FIG. 3. Specifically, the Alaska Airlines Visa Credit Card option 414 has been elevated to the top, despite the American Express option 416 being the consumer client's preferred card. For example, the consumer client in this case may be purchasing airfare on Alaska Airlines. At checkout, when the consumer client chooses the option of “Pay with PayPal,” the user's UI is directed to PayPal's checkout screen. Having identified the promotions offered by each of the funding instruments, and determining a ranking of the available funding instruments, the UI may, in this instance, present the funding instruments in an order based on that ranking. In other words, the most preferred funding instrument will show up at the top of the list, and the least preferred at the bottom.

In a preferred embodiment, all the decisioning is performed by the payment provider. Since the payment provider maintains credit cards and other funding instruments linked to consumer client accounts as well as has connections with merchants, the payment provider is well positioned for making the determinations described above. For example, the payment processor has knowledge of what funding instruments are available for a consumer client, what promotions are being offered by those funding instruments, and the merchants to which those promotions apply, and thus can provide an intelligent determination of what may be the best funding instrument to use for a particular purchase. For example, if the consumer client is purchasing groceries online, and a first funding instrument option provides 3% cash back on groceries while a second funding instrument is only offering 2%, the payment provider will communicate this by populating the first funding instrument in a more prominent position than the second funding instrument on the checkout UI.

In some embodiments, the promotional amount may be displayed alongside the funding instrument. As shown in FIG. 4b, the first funding instrument is shown in the top position along with the 3% cash back that's offered. Likewise, the second funding instrument is displayed with the 2% cash back offer. This information is provided to the consumer client via the UI so that the consumer client can have a choice to make the ultimate decision. The consumer client could conceivably choose a points offer that's seemingly inferior to a cash back offer if the consumer client values those points more at the moment. For example, the consumer client may be close to a threshold at which the points can be redeemable for a flight or a free night of hotel. Thus, it's important that despite the system being able to objectively suggest a funding instruments based on certain metrics, that the consumer client remains the final arbiter of how the transaction is paid for.

In some embodiments, the promotions offered by some of the funding instruments may be determined dynamically. For example, in certain situations, the system may have the authority to increase a reward amount of the promotion being offered. That is, if a consumer client selects a first funding instrument because that funding instrument is offering 4× on points for visits to the gas station, and second funding instrument may authorize the system to bump an original offer of, for example, 3% to 5%, thereby attempting to capture this transaction for the second funding instrument.

In some embodiments, this change may be presented on the UI at the time the user initiates checkout with the payment provider. Alternatively, this change in offers may occur after the consumer client has indicated a choice by clicking on the funding instrument, but before the consumer client clicks the complete button. The UI, may in some instances, display a graphic or animation that draws the consumer client's attention to that change so that it'll be review prior to a completion of a transaction.

In some embodiments, a two-party integration is implement. An example of this two-party integration is where a consumer client transacts directly with a merchant (e.g., John buys a pair of shoes from www.macys.com). In these cases, the payment provider may be partnered with the merchant. For example, as part of the partnership, Macy's may integrate with PayPal to provide PayPal as a checkout option. Thus, when a consumer client uses PayPal checkout on www.macys.com, the system will determine which of the funding instruments held in the PayPal wallet has the best rewards for a purchase from Macy's. Upon making that determination, PayPal may promote the display of that funding instrument on the checkout UI.

In some embodiments, three-party integration may be instituted. An example of a three-party integration is where a consumer client engages in a transaction on a marketplace like eBay or Amazon. The marketplace host intermediates the transaction between the consumer client and merchant (Bill buys a smart watch from a merchant on eBay). In some embodiments, the marketplace host handles the payment process for the transactions. As such, information about available promotions related to the merchant may be obtained from the merchant by way of the marketplace host. In some instances, the payment provider may be in direct contact with the merchant to obtain this information.

In some embodiments, the system described above may be integrated with in-store payment platforms. In applying the system to in-store (i.e., offline) applications, preferences from the merchant and/or consumer can be collected from, for example, point-of-sales (POS) terminals. Individual merchant preferences may be collected during onboarding of the merchant onto the instore product. For example, the merchant preferred card options can be presented at the POS terminal for the consumer.

In the same way, the consumer can communicate preferences to the POS terminal and thus may be reminded of the preferred funding instruments with which to pay. In some instances, there's a consumer preference to use cobranded cards issued by merchant/issuer combinations. A typical example of such a use cases is a consumer who goes to Starbucks for coffee every day. If the consumer uses his Starbucks issued card regularly (e.g., so that he can accumulate more points), his Starbucks card may be presented as the preferred funding instrument option. In other words, consumer behavior may provide an additional signal for the system to collect and maintain as indicators that contribute to a consumer's preferences.

The user device (i.e., the computing device) described above may be one of a variety of devices including but not limited to a smartphone, a tablet, a laptop and a pair of augmented reality spectacles. Each of these devices embodies some processing capabilities and an ability to connect to a network (e.g., the internet, a LAN, a WAN, etc.). Each device also includes a display element for displaying a variety of information. The combination of these features (display element, processing capabilities and connectivity) on the mobile communications enables a user to perform a variety of essential and useful functions.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

In some embodiments, user preferences (i.e., consumer client preferences) are taken into account during the decisioning by the system. For example, a consumer client may favor points of a first funding instrument over a second funding instrument. So all else held equal, the consumer client would want the first funding instrument to be presented for payment with priority over the second funding instrument. An example of such a preference could be that a consumer client values one loyalty point on one funding instrument to be worth the equivalent of two loyalty points on a second funding instrument. To account for this, a user preference may be set to adjust the ratio so that the funding instrument preference is appropriately weighted. Other types of weighting and/or adjustments can be contemplated. Ultimately, the user may fine tune how the funding instruments are ranked.

In some embodiments, the merchant may also define preferences. For example, a merchant may indicate that the merchant doesn't accept a particular card. That is, if a merchant doesn't wish the pay the higher fees for transactions processed by American Express, the merchant can choose to indicate that American Express is not an acceptable form of payment. The system will take into account this information and identify a subset of funding instruments that fit the criteria as defined by the merchant's preferences. In this example, all American Express issued funding instruments would be omitted, while the remaining subset of funding instruments are considered for the ranking.

While the above embodiments describe a rules based system, alternative embodiments may contemplate a content filtering recommendation system or singular value decomposition (SVD) matrix refactorization. A recommendation engine can be implemented with collaborative filtering. For example, model-based collaborative filtering with matrix factorization based algorithm can be used in a preferred implementation. Various features of incentives and similar user choices can play a vital role in the final ranking of funding instruments.

In some embodiments, historical data about the consumer client may be used to determine which funding instrument is preferred. For example, if the user has historically used one funding instrument to pay for a specific type of transaction, then some weight may be assigned based on this historical data. The historical data may be time constrained so that older data carries less weight than newer data. Also, there may be a hard cutoff as to how old the data may be to be considered.

In some embodiments, location services may be used to determine what type of card is to be used. For example, if a consumer client is traveling abroad, or shopping with a merchant that requires a different currency, then the funding instruments may be presented as a reflection of this. For instance, such factors such as the foreign exchange rate offered by each card, as well as the fees (if any) assessed by the card for a foreign purchase, may be considered. As such, the cheapest option for the transaction may be presented as the best option.

In alternative embodiments, certain characteristics of the funding instrument may further be taken into consideration. For example, if a funding instrument provides price and/or damage protection on purchases, a consumer client may be inclined to use it for big ticket purchase items for the protection offered even though a cash back might be offered by an alternate card. The system may also assign a cash value to the protections provided by a particular funding instrument and weigh it against percentage cash back offered by an alternate funding instrument.

Many different factors may be evaluated and considered using this system. As the number of factors increase, so will the value of evaluating all the options provided and choosing the best one available. The factors described herein are for exemplary purposes only. One of ordinary skill in the art can appreciate that multiple other factors may be considered. However, the underlying technology is that many transaction-related factors can be considered when making a recommendation on a funding instrument.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples of the disclosure. A phrase such an “implementation” may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the terms “include,” “have,” and “the like” are used in the description or the claims, such terms are intended to be inclusive in a manner similar to the term “comprise” as “comprise” is interpreted when employed as a transitional word in a claim.

The word “exemplary” is used herein to mean “serving as an example, instance, or illustration.” Any implementation described herein as “exemplary” is not necessarily to be construed as preferred or advantageous over other implementations.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A system for provisioning of scalable cross domain contextual vaulting comprising:
a non-transitory memory storing instructions; and
one or more hardware processors coupled to the non-transitory memory and configured to read the instructions from the non-transitory memory to cause the system to perform operations comprising:
receiving, at a payment provider, an initiation of a checkout at a partner merchant by a consumer client;
identifying a set of funding instruments vaulted in the consumer client's digital wallet associated with the payment provider;
identifying promotions offered by each of the set of funding instruments at the partner merchant;
determining, based on the promotions offered, a ranking of the set of funding instruments; and
presenting, to the consumer client, payment options for the checkout based on the ranking of the set of funding instruments.

2. The system of claim 1, wherein the promotions are funding instrument related promotions, and wherein each of the promotions is applied when the consumer client selects a funding instrument that corresponds to the promotions to pay at checkout.

3. The system of claim 1, wherein the payment options presented to the consumer for the checkout includes, for each of the set of funding instruments, information corresponding to a promotion offered for a corresponding funding instrument.

4. The system of claim 1, wherein the operations further comprise:
determining, based on preferences associated with the partner merchant, a set of acceptable types of funding instruments; and
identifying a subset of funding instruments based on the set of acceptable types of funding instruments.

5. The system of claim 4, wherein the ranking of the set of funding instruments is determined based on the identified subset.

6. The system of claim 1, wherein the operations further comprise identifying preferences associated with the user, wherein the ranking of the set of funding instruments is determined further based on the identified preferences associated with the user.

7. The system of claim 1, wherein the set of funding instruments vaulted in the consumer client's digital wallet associated with the payment provider are linked to the payment provider, and wherein the promotions offered by the each of the set of funding instruments is extracted from the linked accounts.

8. A method for provisioning of scalable cross domain contextual vaulting comprising:
receiving, at a payment provider, an initiation of a checkout at a partner merchant by a consumer client;
identifying a set of funding instruments vaulted in the consumer client's digital wallet associated with the payment provider;
identifying promotions offered by each of the set of funding instruments at the partner merchant;
determining, based on the promotions offered, a ranking of the set of funding instruments; and
presenting, to the consumer client, payment options for the checkout based on the ranking of the set of funding instruments.

9. The method of claim 8, wherein the promotions are funding instrument related promotions, and wherein each of the promotions is applied when the consumer client selects a funding instrument that corresponds to the promotions to pay at checkout.

10. The method of claim 8, wherein the payment options presented to the consumer for the checkout includes, for each of the set of funding instruments, information corresponding to a promotion offered for a corresponding funding instrument.

11. The method of claim 8, wherein the operations further comprise:
determining, based on preferences associated with the partner merchant, a set of acceptable types of funding instruments; and
identifying a subset of funding instruments based on the set of acceptable types of funding instruments.

12. The method of claim 11, wherein the ranking of the set of funding instruments is determined based on the identified subset.

13. The method of claim 8, wherein the operations further comprise identifying preferences associated with the user, wherein the ranking of the set of funding instruments is determined further based on the identified preferences associated with the user.

14. The method of claim 8, wherein the set of funding instruments vaulted in the consumer client's digital wallet associated with the payment provider are linked to the payment provider, and wherein the promotions offered by the each of the set of funding instruments is extracted from the linked accounts.

15. A non-transitory machine-readable medium having stored thereon machine-readable instructions executable to cause performance of operations comprising:
receiving, at a payment provider, an initiation of a checkout at a partner merchant by a consumer client;
identifying a set of funding instruments vaulted in the consumer client's digital wallet associated with the payment provider;
identifying promotions offered by each of the set of funding instruments at the partner merchant;
determining, based on the promotions offered, a ranking of the set of funding instruments; and
presenting, to the consumer client, payment options for the checkout based on the ranking of the set of funding instruments.

16. The non-transitory machine-readable medium of claim 15, wherein the promotions are funding instrument related promotions, and wherein each of the promotions is applied when the consumer client selects a funding instrument that corresponds to the promotions to pay at checkout.

17. The non-transitory machine-readable medium of claim 15, wherein the payment options presented to the consumer for the checkout includes, for each of the set of funding instruments, information corresponding to a promotion offered for a corresponding funding instrument.

18. The non-transitory machine-readable medium of claim 15, wherein the operations further comprise:
determining, based on preferences associated with the partner merchant, a set of acceptable types of funding instruments; and
identifying a subset of funding instruments based on the set of acceptable types of funding instruments.

19. The non-transitory machine-readable medium of claim 18, wherein the ranking of the set of funding instruments is determined based on the identified subset.

20. The non-transitory machine-readable medium of claim 15, wherein the operations further comprise identifying preferences associated with the user, wherein the ranking of the set of funding instruments is determined further based on the identified preferences associated with the user.
